(19) United States
(12) Patent Application Publication
(10) Pub. No.: US 2011/0121022 A1
(43) Pub. Date: May 26, 2011

(54) Product Dispenser With Low Product Indicator

(76) Inventors: Andrew B. Sholl, Cranbury, NJ (US); John Gelardi, Midlothian, VA (US); Aaron L. Bates, Moseley, VA (US); Laurel Thomas, Richmond, VA (US); Caleb S. Loftin, Richmond, VA (US)

(21) Appl. No.: 12/890,637

(22) Filed: Sep. 25, 2010

Related U.S. Application Data
(63) Continuation-in-part of application No. 12/777,444, filed on May 11, 2010, now Pat. No. 7,922,437.
(60) Provisional application No. 61/263,767, filed on Nov. 23, 2009.

(51) Int. Cl. B67D 7/06

(52) U.S. Cl. 222/23

(57) ABSTRACT

A product dispenser including a frame configured to support a plurality of products and flag element connected to the frame, the flag element being moveable relative to the frame from a first, un-deployed configuration when the flag element is engaged with at least one of the products, to a second, deployed configuration when the flag element is not engaged with the products.

### PRIORITY

This application is a continuation-in-part of U.S. patent application Ser. No. 12/777,444 filed on May 11, 2010 (pending), the entire contents of which are incorporated herein by reference, which claims priority from U.S. Provisional Patent Application No. 61/263,767 filed on Nov. 23, 2009 (pending), the entire contents of which are incorporated herein by reference.

### FIELD

This application relates to apparatus and systems for dispensing products and, more particularly, to product dispensing apparatus and systems configured to provide an indication when product level is low.

### BACKGROUND

Products are typically shipped to retailers in bulk by enclosing multiple individual product units in a container, such as a carton or box. For example, canned foods may be shipped to a retailer in a box containing twenty-four individual cans. Then, it is typically the retailer's obligation to remove the individual product units from the container and present them (e.g., on a shelf) to consumers.

Alternatives to the traditional package-ship-unpack-display model are being developed in an effort to improve operating efficiency. For example, U.S. patent application Ser. No. 12/777,444 discloses a new system for dispensing and displaying products packaged in a container. Specifically, the system includes a frame having a support structure, a product display area and an opening tool. The frame may be positioned on a retailer's shelf and loaded with product simply by placing a container comprising multiple units of product onto the support structure of the frame. As the container is being placed onto the support structure, the opening tool of the frame opens the container in such a manner that product rolls from the container and down to the product display area of the frame under the force of gravity.

Unfortunately, it is often difficult to determine when the container is empty and a new container should be loaded onto the frame. Failure to maintain the frame of the dispenser stocked with product may result in customer dissatisfaction and lost sales.

Accordingly, those skilled in the art continue with research and development efforts directed to apparatus and systems for dispensing products.

### SUMMARY

In one aspect, the disclosed product dispenser with low product indicator may include a frame configured to support a plurality of products and a flag element connected to the frame, the flag element being moveable relative to the frame from a first, un-deployed configuration when the flag element is engaged with at least one of the products, to a second, deployed configuration when the flag element is not engaged with the products.

In another aspect, the disclosed product dispenser with low product indicator may include a frame configured to support a plurality of products and a flag element connected to the frame, the flag element being moveable relative to the frame from a first, un-deployed configuration when the flag element is engaged with at least one of the products, to a second, deployed configuration when the flag element is not engaged with the products, wherein the flag element includes a front face, and wherein the front face is optionally, marked with various text, graphics and colors to indicate a low product condition.

In another aspect, the disclosed product dispenser with low product indicator may include a frame having a first side wall, a second side wall laterally spaced from the first side wall and an upper support surface extending between the first and second side walls, the upper support surface including a front end and a rear end, the front end defining an aperture therein, and a flag element pivotally connected to the frame, the flag element including a front end and a rear end, wherein the flag element is moveable from a first configuration, wherein the front end of the flag element is aligned with the aperture, to a second configuration, wherein the front end of the flag element is displaced from the aperture.

In yet another aspect, the disclosed product dispenser with low product indicator may include a frame having a support surface having longitudinally spaced front end and rear ends, a plurality of products positioned on the support surface, wherein the support surface is configured to urge the products to the front end of the support surface, and a flag element connected to the frame and moveable relative to the frame between a first configuration and a second configuration, wherein the flag element is in the first configuration when the flag element is engaged with at least one of the products, and wherein the flag element is in the second configuration when the flag element is not engaged with the products.

Other aspects of the disclosed product dispenser with low product indicator will become apparent from the following detailed description, the accompanying drawings and the appended claims.

### BRIEF DESCRIPTION OF THE DRAWINGS

FIG. 1 is an exploded front perspective view of one aspect of the disclosed product dispenser with low product indicator;

FIG. 2 is a front perspective view of the flag element of the product dispenser with low product indicator of FIG. 1;

FIG. 3 is a side elevational view of the product dispenser with low product indicator of FIG. 1, shown with the flag element in a first configuration;

FIG. 4 is a side elevational view of the product dispenser with low product indicator of FIG. 3, shown with the flag element in a second, deployed configuration; and

FIG. 5 is a front perspective view of the product dispenser with low product indicator of FIG. 4.

### DETAILED DESCRIPTION

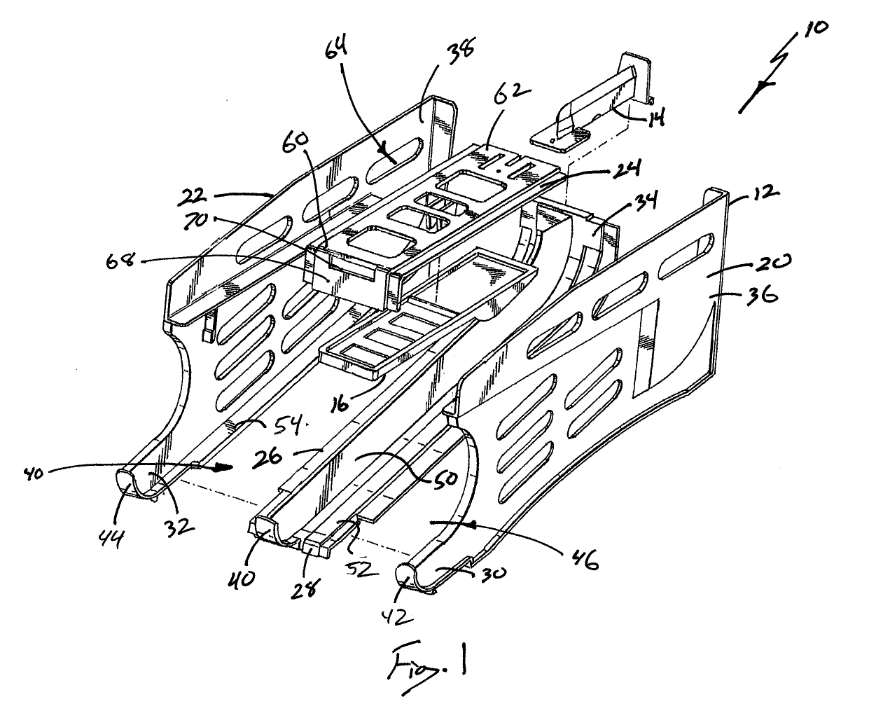

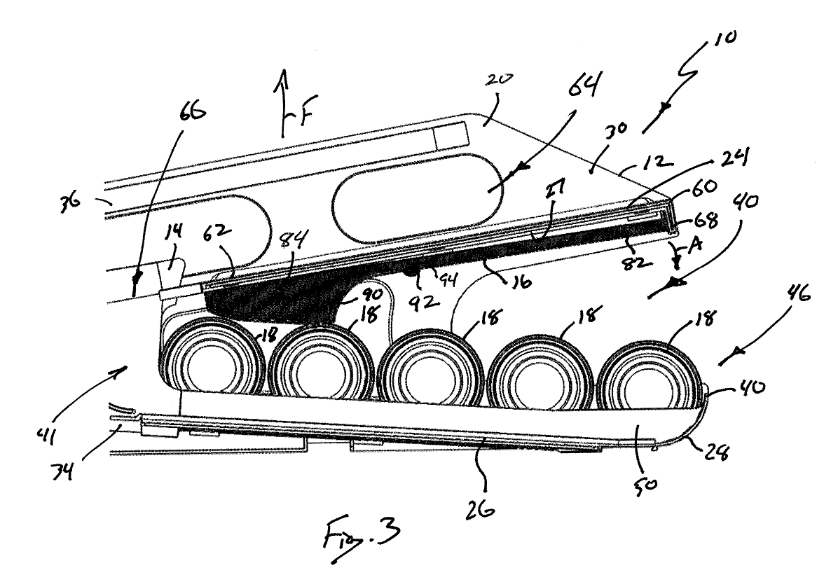

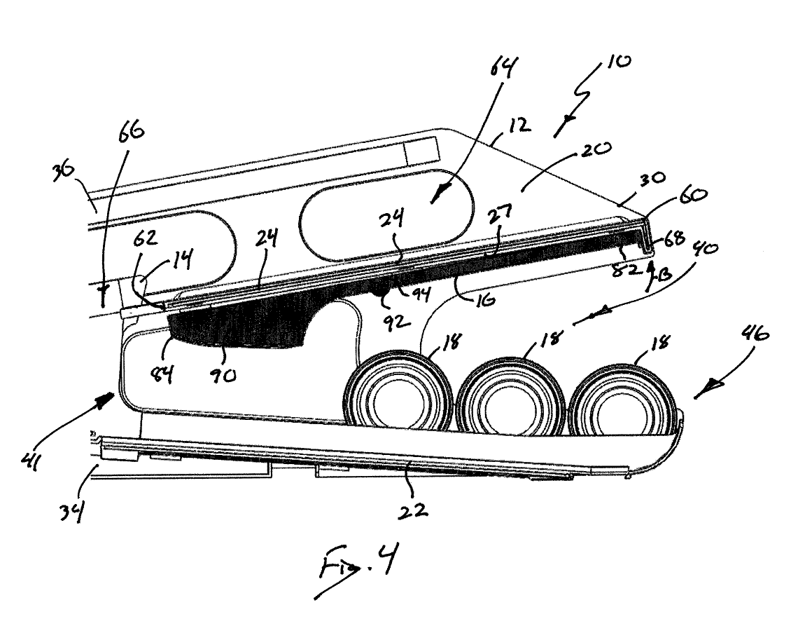

Referring to FIG. 1, one aspect of the disclosed product dispenser with low product indicator, generally designated 10, may include a frame 12, an optional cutting element 14 and a flag element 16. As will be described in greater detail below, the frame 12 may support a number of units of product 18 (FIGS. 3 and 4) and the flag element 16 may pivot relative to the frame 12 to provide an indication when a low product condition is present in the frame 12.

The frame 12 may include a first side wall 20, a second side wall 22, an upper support surface 24 and a lower support surface 26. The first side wall 20 may be laterally spaced from the second side wall 22, and may be generally parallel with the second side wall 22.

The lower support surface 26 may extend between the first 20 and second 22 side walls, and may include a front end 28 that extends to the front ends 30, 32 of the side walls 20, 22 and a rear end 34 that extends to the rear ends 36, 38 of the side walls 20, 22. Therefore, the lower support surface 26 and the side walls 20, 22 may define a lower level 40 of the frame 12.

As best shown in FIGS. 3 and 4, the lower support surface 26 may be inclined from the front end 28 to the rear end 34 (i.e., the rear end 34 may be elevated relative to the front end 28) such that product 18 deposited at the rear end 34 of the lower support surface 26 rolls down to the front end 28 of the lower support surface 26 under the force of gravity. The extent of the incline of the lower support surface 26 may be dictated by, among other things, the coefficient of friction of the material used to form the frame 12 and the shape of the products 18 (FIGS. 3 and 4) to be dispensed by the dispenser 10.

Referring back to FIG. 1, one or more stops 40, 42, 44 may be positioned proximate (i.e., at or near) the front end 28 of the lower support surface 26 to prevent product 18 (FIGS. 3 and 4) from rolling beyond the front end 28 of the lower support surface 26. For example, stop 40 may be connected to (e.g., integral with) the lower support surface 26, stop 42 may be connected to (e.g., integral with) the first side wall 20, and stop 44 may be connected to (e.g., integral with) the second side wall 22. Therefore, the stops 40, 42, 44 may collect product 18 at the front end 28 of the lower support surface 26, thereby establishing a product display area 46 at the front end 28 of the lower support surface 26.

In one particular implementation, a divider 50 may extend from the front end 28 of the lower support surface 26 to the rear end 34 of the lower support surface 26 to divide the lower level 40 into a first product channel 52 and a second product channel 54. The first product channel 52 may be defined by the lower support surface 26, the first side wall 20 and the divider 50, and may extend from proximate the rear end 34 of the lower support surface 26 to the front end 28 of the lower support surface 26. The second product channel 54 may be defined by the lower support surface 26, the second side wall 22 and the divider 50, and may extend from proximate the rear end 34 of the lower support surface 26 to the front end 28 of the lower support surface 26. While two product channels 52, 54 are shown and described, those skilled in the art will appreciate that the frame 12 may be constructed to provide only one product channel or more than two product channels, without departing from the scope of the present disclosure.

The upper support surface 24 may extend between the first 20 and second 22 side walls, and may include a front end 60 that extends to the front ends 30, 32 of the side walls 20, 22 and a rear end 62 that extends toward, but not to, the rear ends 36, 38 of the side walls 20, 22, thereby defining an upper level 64 of the frame 12. The spacing between the rear end 62 of the upper support surface 24 and the rear ends 36, 38 of the side walls 20, 22 may define an opening 66 (FIG. 3), which may function as a chute to allow product 18 to move from the upper level 64 to the lower level 40 of the frame 12.

As best shown in FIGS. 3 and 4, the upper support surface 24 may be declined from the front end 60 to the rear end 62 (i.e., the front end 60 may be elevated relative to the rear end 62). Therefore, product 18 supported by the upper support surface 24 may roll under the force of gravity down to the rear end 62 of the upper support surface 24, through the opening 66 and, ultimately, to the lower level 40 of the frame 12.

Referring back to FIG. 1, the front end 60 of the upper support surface 24 may include a face panel 68 connected thereto. The face panel 68 may be integral with the upper support surface 24 or may be connected to the upper support surface 24 using mechanical fasteners, adhesives or the like. The face panel 68 may extend downward (i.e., toward the lower level 40) from the upper support surface 24, and may define an aperture 70 therein. As will be described in greater detail below, the flag element 16 may produce an indication in the aperture 70 when a low product condition is present in the frame 12.

The cutting element 14 may be connected to the frame 12 proximate the rear end 62 of the upper support surface 24. The cutting element 14 may be positioned to form a cut in a container (not shown) when the container is loaded onto the upper support surface 24. The cut formed in the container by the cutting element 14 may produce an opening through which product 18 may exit the container and roll from the upper level 64 of the frame 12 to the lower level 40 and, ultimately, to the product display area 46.

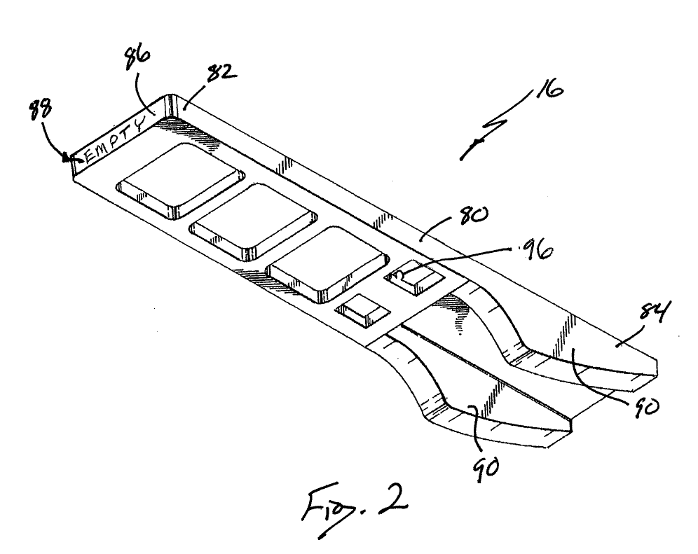

As shown in FIG. 2, the flag element 16 may include an elongated body 80 having a front end 82 and a rear end 84. The front end 82 of the flag element 16 may be longitudinally spaced from the rear end 84 by a sufficient distance such that, when connected to the frame 12, the front end 82 of the flag element 16 extends to proximate the front end 60 of the upper support surface 24 and the rear end 84 of the flag element 16 extends to proximate the rear end 2 of the upper support surface 24

The front end 82 of the flag element 16 may include a face 86, which may optionally be marked with indicia 88. As one example, the face 86 of the flag element 16 may be marked with text, such as “LOW” or “EMPTY”, to indicate that the dispenser 10 is in a low product condition. As another example, the face 86 of the flag element 16 may be marked with graphics that indicate that the dispenser 10 is in a low product condition. In yet another example, the face 86 of the flag element 16 may be colored (e.g., red) to indicate that the dispenser 10 is in a low product condition.

In one optional implementation, the surface area of the face 86 of the flag element 16 may be greater than the area of the aperture 70 of the face panel 68 of the frame 12 such that the face 86 of the flag element 16 fills the aperture 70 when the dispenser 10 is in a low product condition.

The rear end 84 of the flag element 16 may include one or more protrusions 90 extending downward (i.e., toward the lower level 40) therefrom. Two protrusions 90 are shown in FIG. 2 to correspond with the two product channels 52, 54 of the lower support surface 26. The protrusions 90 may be sufficiently large to engage product 18 (FIG. 3) positioned in the product channels 52, 54, and to provide the rear end 84 of the flag element 16 with sufficient weight (i.e., a greater weight than the front end 82 of the flag element 16) to achieve the desired counterbalancing of the rear end 84 when the flag element 16 is connected to the frame 12, as is discussed in greater detail below.

Referring to FIGS. 3 and 4, the flag element 16 may be pivotally connected to the frame 12 at a pivot point 92. In one specific construction, the flag element 16 may be pivotally connected to the underside 27 of the upper support structure 24 at a pivot point 92 by engaging a fulcrum 94 connected to the underside 27 of the upper support structure 24 with a rounded protrusion 96 extending from the flag element 16. As an example, the engagement between the fulcrum 94 and the rounded protrusion 96 may be a ball-and-socket-type engagement that facilitates pivoting of the flag element 16 about the pivot point 92 through a plane that is generally parallel with a plane defined by one of the side walls 20, 22.

The flag element 16 may be connected to the frame 12 such that the front end 82 of the flag element 16 is positioned proximate the face panel 68 and the rear end 84 of the flag element 16 is positioned proximate the rear portion 41 of the lower level 40. As shown in FIG. 3, the protrusions 90 at the rear end 84 of the flag element 16 may be engaged with product 18 positioned in the product channels 52, 54 at the rear portion 41 of the lower level 40. Therefore, the products 18 engaged with the protrusions 90 may apply an upward force (arrow F) to the rear end 84 of the flag element 16, thereby causing the flag element 16 to pivot about the pivot point 92 and urging the front end 82 of the flag element 16 downward (arrow A) and out of alignment with the aperture 70 of the face panel 68.

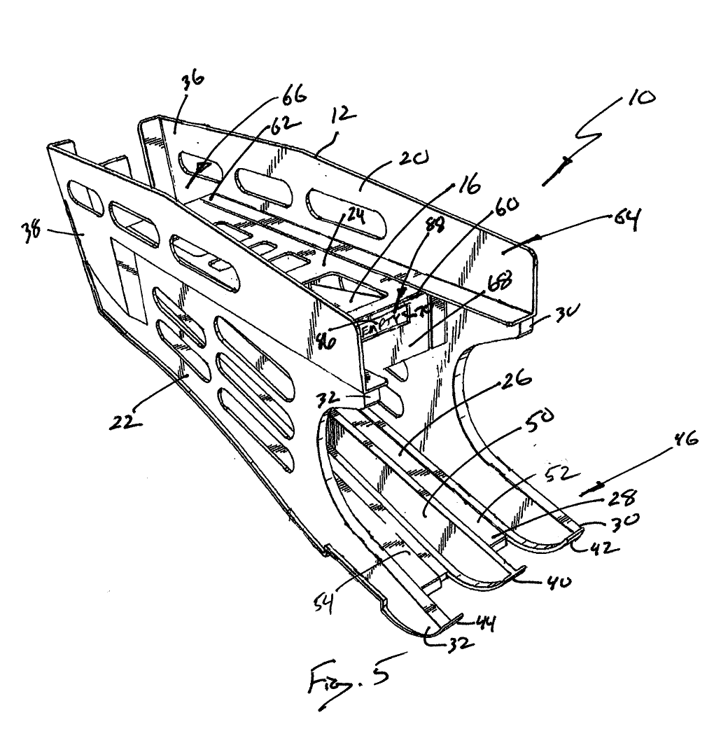

As shown in FIGS. 4 and 5, when no products 18 are positioned below, and engaged with, the protrusions 90 of the flag element 16, the weight and/or balancing of the rear end 84 of the flag element 16 relative to the front end 82 of the flag element 16 may cause the flag element 16 to pivot about pivot point 92 such that the front end 82 of the flag element 16 is urged upward (arrow B) and into alignment with the aperture 70 of the face panel 68. Therefore, with the front end 82 of the flag element 16 aligned with the aperture 70 of the face panel 86, the face 86 of the flag element 16, including indicia 88, may be viewable through the aperture 70, thereby providing a visual indication of the low product condition.

Accordingly, the disclosed product dispenser 10 is configured to provide a visual indication that a low product condition is present. Specifically, the disclosed product dispenser 10 is configured to deploy the flag element 16 when the number of units of product 18 in the lower level 40 of the product dispenser 10 has dropped below a threshold value, thereby signaling a user (e.g., a stock clerk) to load additional product 18.

Although various aspects of the disclosed product dispenser with low product indicator have been shown and described, modifications may occur to those skilled in the art upon reading the specification. The present application includes such modifications and is limited only by the scope of the claims.

What is claimed is:

1. A product dispenser comprising:
a frame configured to support a plurality of products; and
a flag element connected to said frame, said flag element being moveable relative to said frame from a first, un-deployed configuration when said flag element is engaged with at least one product of said plurality, to a second, deployed configuration when said flag element is not engaged with said plurality of products.

2. The product dispenser of claim 1 wherein said frame comprises a first side wall laterally spaced from a second side wall, and a support surface between said first and said second side walls.

3. The product dispenser of claim 2 further comprising a container supported on said support surface.

4. The product dispenser of claim 2 wherein said flag element is pivotally connected to said support surface.

5. The product dispenser of claim 2 wherein said support surface includes a panel connected thereto, said panel defining an aperture therein, and wherein said flag element is aligned with said aperture when said flag element is in said second configuration.

6. The product dispenser of claim 5 wherein said flag element defines a face, and wherein said face is viewable through said aperture when said flag element is in said second configuration.

7. The product dispenser of claim 6 wherein said face is marked with indicia.

8. The product dispenser of claim 1 wherein said flag element is biased to said second configuration.

9. The product dispenser of claim 2 wherein said support surface comprises a first end and a second end, and wherein said second end is elevated relative to said first end.

10. A product dispenser comprising:
a frame comprising:
a first side wall;
a second side wall laterally spaced from said first side wall; and
a support surface extending between said first and second side walls, said support surface comprising a front end and a rear end, said front end defining an aperture; and
a flag element pivotally connected to said frame, said flag element comprising a front end and a rear end, wherein said flag element is moveable from a first configuration, wherein said front end of said flag element is aligned with said aperture, to a second configuration, wherein said front end of said flag element is displaced from said aperture.

11. The product dispenser of claim 10 wherein said flag element is pivotally connected to said support surface.

12. The product dispenser of claim 10 wherein said support surface comprises a face panel connected thereto, and wherein said face panel defines said aperture.

13. The product dispenser of claim 10 wherein said front end of said flag element defines a face, and wherein said face is displayed in said aperture when said flag element is in said first configuration.

14. The product dispenser of claim 13 wherein said face is marked with indicia.

15. The product dispenser of claim 10 wherein said flag element is biased to said first configuration.

16. The product dispenser of claim 10 wherein said rear end of said flag element comprises a protrusion extending therefrom.

17. The product dispenser of claim 10 wherein said rear end of said flag element is engaged with a product supported by said frame when said flag element is in said second configuration.

18. The product dispenser of claim 10 further comprising a container positioned on said support surface.

19. The product dispenser of claim 10 wherein said front end of said support surface is elevated relative to said rear end of said support surface.

20. A product dispenser comprising:
a frame comprising a support surface having longitudinally spaced front and rear ends;
a plurality of products positioned on said support surface, wherein said support surface is configured to urge said plurality of products to said front end of said support surface; and
a flag element connected to said frame and moveable relative to said frame between a first configuration and a second configuration,
wherein said flag element is in said first configuration when said flag element is engaged with at least one product of said plurality of products, and wherein said flag element is in said second configuration when said flag element is not engaged with said plurality of products.
